(19) United States
(12) Patent Application Publication
(10) Pub. No.: US 2025/0335167 A1
(43) Pub. Date: Oct. 30, 2025

(54) APPLICATION OPTIMIZATION FRAMEWORK

(71) Applicant: Oracle International Corporation, Redwood City, CA (US)

(72) Inventors: Manish Verma, Cupertino, CA (US); Guigen Zhang, Pleasanton, CA (US); Amresh Kumar, Oakville (CA)

(21) Appl. No.: 18/645,141

(22) Filed: Apr. 24, 2024

(51) Int. Cl. G06F 8/41; G06F 8/77

(52) U.S. Cl. CPC G06F 8/443; G06F 8/77

(57) ABSTRACT

Various embodiments of the present technology generally relate to systems and methods for providing a framework for optimizing configuration settings of application instances. In certain embodiments, a method may comprise operating an optimizer service to implement an application optimizer process to improve performance of an application instance. The process may include receiving a plurality of checks from an application development system for the application instance, the plurality of checks including scans and fixes for configuration settings of the application instance. The process may further include executing the scans on the application instance, determining a selection of fixes configured to improve the performance of the application instance in response to a result of the scans, providing a notification to the application instance recommending user implementation of the selection of fixes, and providing analytics data corresponding to the user implementation of the selection of fixes to the application development system.

### TECHNICAL FIELD

Various embodiments of the present technology generally relate to the improvement in performance of and user experience with applications and software services. More specifically, embodiments of the present technology relate to systems and methods for providing a framework to optimize applications via efficiently analyzing and addressing problems with user configurations of the applications.

### BACKGROUND

In software application environments, including software as a service (SaaS) and cloud-based application deployments, users (such as SaaS customers or clients, and their associated system administrators or “admins”) may encounter problems or inefficiencies with the application performance. These issues may include slowdown or lag, unresponsiveness, unexpected behavior, inability to locate desired configuration settings, unfamiliarity or lack of awareness of application features or capabilities, or other issues.

In some cases, users may continue to use the application despite the inefficiencies, which may add to user frustration, dissatisfaction, and loss of customers. In other examples, users may submit service requests (SRs) to customer support for the application. Customer support may need to evaluate each SR, attempt to work with customer admins to resolve the issue, determine an appropriate department within the application development departments to address bugs or issues, and otherwise work to resolve problems that arise. Addressing SRs in this manner may be time consuming for both the application developer and the customer, slow, and lead to customer aggravation or frustration.

In reality, a large number of problems with applications may not be due to bugs or errors in the application, but rather are due to setup or configuration issues that are customer-fixable. However, these configuration issues may still lead to customer frustration and SRs that are time-consuming for both the customer and developer.

Even if a developer produces guidance on how to avoid configuration problems, or determined that a configuration problem exists in a particular customer's setup, the developer may not know how to reach the appropriate administrator at the customer organization. For example, the developer may have no contact information for an admin, or may have old contact information from previous SRs, but that admin may have moved on from the position and may no longer be reachable. Accordingly, there exists a need for improved systems and methods for application optimization, which can reliably reach an appropriate administrator for client instances of the application.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for implementing an application optimization framework. In an embodiment, an application optimizer service system may comprise one or more processors, and a memory having stored thereon instructions that, upon execution by the one or more processors, cause the one or more processors to implement an application optimizer process to improve performance of an application instance, wherein the application optimizer service system is executed in a developer domain and the application instance is executed in a customer domain. The application optimizer service system may receive a plurality of checks from an application development system for the application instance, the plurality of checks including scans and fixes for configuration settings of the application instance. The application optimizer service system may receive a request to run an optimizer service on the application instance, execute the scans on the application instance in response to the request, determine a selection of fixes configured to improve the performance of the application instance based on a result of the scans, provide a notification to the application instance recommending user implementation of the selection of fixes, and provide analytics data corresponding to the user implementation of the selection of fixes to the application development system

In some embodiments of the application optimizer service system, the request to run the optimizer service may be received from an optimizer agent running in the customer domain. In another embodiment, the request to run the optimizer service may be based on a scheduled scan set by the application development system in the developer domain. The application optimizer service system may perform the scheduled scan on a plurality of customer application instances including the application instance, and determine separate selections of fixes for each of the plurality of customer application instances. The application optimizer service system may further generate the analytics data based on user implementations of the separate selections of fixes from the plurality of customer application instances. In some examples, the application optimizer service system may maintain a database of the plurality of checks, and provide an API (application programming interface) to the application development system enabling modification of the plurality of checks. In some embodiments, the fixes may include instructions to manually adjust the configuration settings to improve performance. In another example, the fixes may include instructions executable by the customer domain to automatically adjust the configuration settings in response to a button selection by a user. The application optimizer service system may determine the selection of fixes to include a subset less than all of the fixes identified by the scans that could improve the performance of the application instance. In some examples, to execute the scans on the application instance, the application optimizer service system may create a job control pod configured to retrieve the scans from the database, run the scans on the application instance, receive the result of the scans from the application instance, and provide the result of the scans to the application optimizer service system.

In an alternative embodiment, a method may comprise operating an application optimizer service system to implement an application optimizer process to improve performance of an application instance, wherein the application optimizer service system is executed in a developer domain and the application instance is executed in a customer domain. The application optimizer process may include receiving a plurality of checks from an application development system for the application instance, the plurality of checks including scans and fixes for configuration settings of the application instance. The process may further include receiving a request to run an optimizer service on the application instance, executing the scans on the application instance in response to the request, determining a selection of fixes configured to improve the performance of the application instance in response to a result of the scans, providing a notification to the application instance recommending user implementation of the selection of fixes, and providing analytics data corresponding to the user implementation of the selection of fixes to the application development system.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of an example system configured to implement an application optimization framework, in accordance with certain embodiments of the present disclosure;

FIG. 2 is a flow diagram of an example system for implementing an application optimization framework, in accordance with certain embodiments of the present disclosure;

FIG. 3 is a diagram of a user interface for an application optimization framework, in accordance with certain embodiments of the present disclosure;

FIG. 4 is a diagram of a user interface for an application optimization framework, in accordance with certain embodiments of the present disclosure;

FIG. 5 is a diagram of a user interface for an application optimization framework, in accordance with certain embodiments of the present disclosure; and

FIG. 6 is a diagram of a system configured to implement an application optimization framework, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

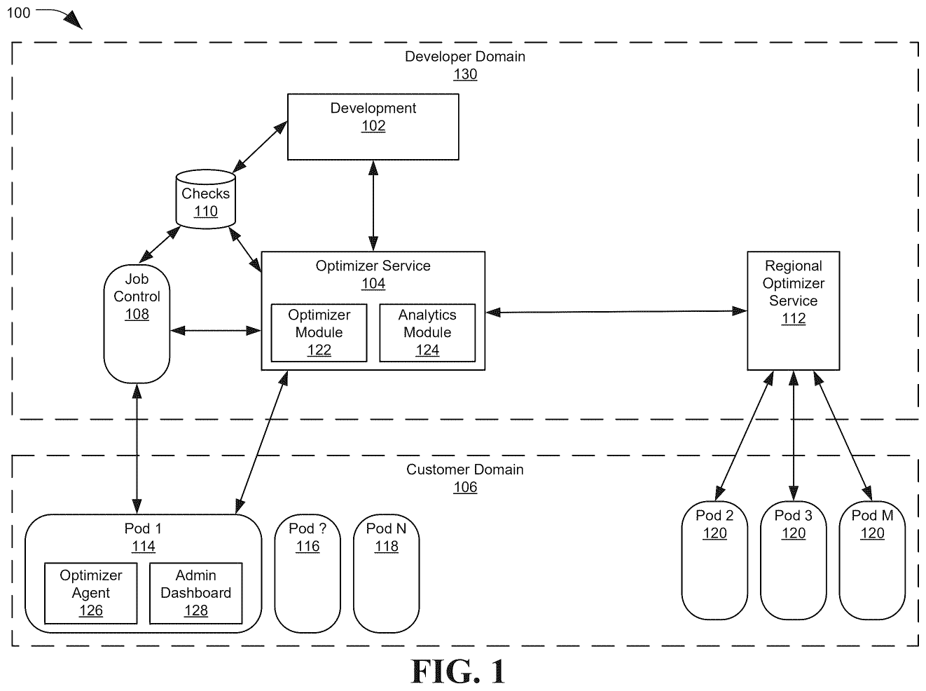

FIG. 1 is a diagram of a system 100 configured to implement an application optimization framework, in accordance with certain embodiments of the present disclosure. The example system 100 may include an application software environment, such as a SaaS or platform as a service (PaaS) model deployed in a cloud environment, in which an application may be provided to customers (e.g., individual users, organizations, or other user groups). Each customer may have its own instance of the application, and may have different or individualized configuration settings applied for the application. Configuration or setup settings for application instances may include settings for the application itself, such as when to run jobs, how to allocate computing resources, what data and logs to store and for how long, user access rights, notification settings, and other application settings. Configuration or setup settings can also include what features are being utilized and how data objects are managed, which may include how employees are set to receive payments through the application, when data fields for an object are blank, and other issues.

The optimization framework provided by system 100 may allow for the seamless and efficient analysis of configuration settings for customers, and for the provision of improvement opportunities, fixes, or other optimizations to an appropriate administrator for the customer's application deployment. System 100 may include a developer domain 130 including development system 102, and an optimizer service 104. Additional elements, such as a job control function or module 108, a database of checks, scans, and fixes 110, and an additional regional optimizer service 112 may also be included. System 100 may also include a customer domain 106 including one or more pods 114, 116, 118, 120. Components of system 100 may communicate via one or more network connections, including wired or wireless, intranet or internet, and within private cloud environments or across public network channels. Components of system 100 may be implemented via one or more computing devices and software systems, including physical and virtual systems, such as physical servers and cloud computing pods.

Developer domain 130 may include computing resources, such as servers, workstations, computers, other computing devices, or cloud computing resources, managed or operated by a developer for the application. Customer domain 106 may include computing resources managed or operated by a customer for the application. In some embodiments, developer domain 130 and customer domain 106 may represent different physical areas, such as facilities operated by a developer and one or more customers, respectively. In some examples, one or both of developer domain 130 and customer domain 106 may be hosted in a cloud environment running out of one or more facilities run by a cloud service provider. In another example, customer domain 106 may be hosted by the developer within the developer domain 130, with customers having one or more application instances managed by the customers (e.g., via pods 114, 116, 118, 120). In yet another example, part of developer domain 130, such as optimizer service 104, may be implemented through on-premises deployment at a location of the customer domain 106. Other configurations are also possible.

Development system 102 may include modules, devices, software, and personnel for development and maintenance of the application. Development system 102 may be used to develop and deploy the application, evaluate errors and bugs, develop patches and updates, manage SRs and customer service, analyze usage trends, and otherwise support the deployment and usage of the application. In some examples, development system 102 may support multiple different applications, or multiple versions of a same application (e.g., free and premium versions that potentially have different capabilities and options).

Development system 102 may detect trends in customer-submitted SRs, analytics run on customer application instances, and other data sources, to identify configuration settings that may result in customer dissatisfaction or operating inefficiencies. Based on the detected trends, development system 102 may produce one or more “checks”. Checks may include both scans to identify whether problematic configurations are implemented on application instances, and related fixes. Fixes may include suggested changes to configuration settings to address identified issues, and may include elements such as step-by-step instructions to change the appropriate settings by a human admin, links and information to explain the underlying settings and their effects, and computer-executable instructions to automatically change the appropriate settings, for example in response to a user clicking a “fix it for me” button. In some examples, checks may include SQL (Sequel) statements which may query database files of configuration settings, or may change configuration settings. Checks may be added, updated, and removed as needed, independent of a release or update cycle of the related application(s). These checks may be stored to a checks database 110, or provided directly to an optimizer service 104. Development system 102 may also review existing checks 110, and may adjust or retire checks, e.g., in response to updates to the application software.

Customer domain 106 may include the application instances for one or more users or customers. In the depicted example, the customer domain 106 may include one or more pods, which may be cloud computing instances that represent a collection of computational resources. Each instance of an application may be executed on one or more pods, and there may be multiple customer application instances in the customer domain. For example, a first customer instance may be implemented on pod 1 114, pod? 116, and pod N 118, and a second customer instance may be implemented on pods 2, 3, and M 120. Running on or alongside a customer application instance may be an optimizer agent 126, and an admin dashboard 128.

The optimizer agent 126 may be a module configured to request an optimizer scan (e.g., from optimizer service 104 or job control 108), execute scans or checks on the application instance, receive notifications or instances of potential optimizations or improvements identified during the scan, receive fixes as instructions or code for implementing the optimizations, display notifications of optimizations and fix details to an admin (e.g., through admin dashboard 128), implement selected fixes, and provide feedback or metrics on the optimizations (e.g., to optimizer service 104). Feedback or metrics may include what notifications were displayed to an admin, which fixes were implemented and which were not, timing of notifications and fix selections, whether any errors or other unexpected behavior was encountered in implementing the fixes, or other details. The feedback may be provided (e.g., via optimizer service 104) to development system 102, which may allow developers to determine what optimizations have been reviewed and accepted by customers, how quickly optimizations were reviewed or accepted, and potential impacts on application performance or SR rate based on the suggested implementations. The development system 102 may use the feedback to develop or adjust checks 110 to further streamline optimizations, identify unclear instructions or unsuccessful fixes, or otherwise optimize application performance. There may be an optimizer agent 126 per customer application instance (e.g., a single agent 126 for an application instance running across pods 114, 116, and 118), one agent 126 per pod (e.g., one each per pod 114, 116, 118), or otherwise distributed.

Admin dashboard 128 may include a user interface (UI) for interacting with the application by an admin user of the customer. The admin dashboard 128 may be provided to users having certain roles or access rights, and may be limited to users tasked with maintaining the customer application instance and configuring it to meet customer requirements. The admin dashboard 128 may provide the user with the ability to adjust configuration settings, user access rights, and other features core to the stability or functioning of the customer application instance. The admin dashboard 128 may interface with the optimizer agent 126 to enable an admin to select when to perform optimizer scans, and may display notifications of potential improvement opportunities or optimizations identified based on the scans. Optimizer agent 126 may be configured to only display optimizer notifications on admin dashboard 128, and therefore the optimization suggestions may be sure to reach the appropriate user for implementing any suggested configuration changes, even if the admin (and any associated contact information) changes over time. An admin may utilize the admin dashboard 128 to review suggested fixes or optimizations, and may follow the provided guidance to manually implement the suggested changes, or, in some embodiments, have the optimizer agent 126 automatically apply a fix via a “fix it for me” button that runs code from checks 110 to implement the configuration changes.

Optimizer service 104 may include a system or module configured to implement an application optimization framework. Optimizer service 104 may be implemented within the application developer's domain, although in some examples it may be implemented within a customer domain 106. In some examples, there may be multiple optimizer services, such as optimizer service 104 and regional optimizer service 112, deployed at different geographic regions in order to better service regionally distributed customers. In some embodiments, there may be a main optimizer service 104 that may coordinate or synchronize with one or more regional optimizer service 112, such as by providing a most recent version of checks 110 to each regional optimizer service 112, and controlling the regional optimizer service 112 to run optimizer scans on local customer application instances (e.g., at pods 120). Optimizer service 104 may provide an interface to development system 102 via which developers can add, update, or remove checks 110 from the database, for example using REST (representational state transfer) APIs (application programming interfaces). Optimizer service 104 may include an optimizer module 122 and an analytics module 124.

Optimizer module 122 may be configured to implement optimizer checks 110 on customer domain 106, and to receive any feedback or results from the checks 110. Optimizer module 122 may be configured to run optimizer scans based on the checks 110 on individual pods (e.g., 114), all pods of a customer application instance (e.g., 114, 116, 118), or on all or multiple customer instances (e.g., pods 114, 116, 118, 120). Optimizer module 122 may run scans in response to a request for a scan received from an optimizer agent 126, based on a schedule set by a user or development 102, based on selected time intervals, or based on other triggers.

In an example implementation, a user may initiate an optimizer scan (e.g., via admin dashboard 128 and optimizer agent 126), which may send a scan request to optimizer module 122. In response to the scan request, optimizer module 122 may retrieve checks for the scan from database 110, and execute the scan on customer application pods (e.g., pods 114, 116, and 118), for example by running SQL query commands. The optimizer module 122 may then receive the results of the scan, which may identify configuration settings that may benefit from changes or optimizations. In some embodiments, rather than running a scan itself, the optimizer module 122 may create or utilize a job control module or pod 108, which may optionally retrieve the checks 110, perform the scan on the client application instance(s), receive the results of the scan, or any combination thereof. Based on the results of the scan, the optimizer module 122 may retrieve one or more “fixes” from the checks database 110, corresponding to identified setup issues or inefficient settings identified in the scan. In some examples, the scans and the fixes are retrieved from checks 110 together, before receiving results of the scan. Optimizer module 122 may provide scan results to the optimizer agent 126, which may include data on both improvement opportunities identified and corresponding fixes. The results may be provided in the form of one or more notifications, or a list of potential optimization changes that the user may elect to make to their application instance configuration. The notification or optimization suggestions may be displayed on the admin dashboard 128, and may include explanations of the settings and suggested changes, instructions or guidance on implementing the changes, and potentially an option to fix the settings automatically by means of a “fix it for me” button. The fixes data provided to the optimizer agent 126 from the optimizer module 122 may include code or SQL commands configured to change settings on the customer instance when executed in response to the “fix it for me” button, for example via optimizer agent 126.

In some examples, the optimizer module 122 may only provide a limited number of suggested fixes to the optimizer agent 126, for example if a large number of potential fixes are identified by the scan. An admin or user may be overwhelmed by receiving too many suggested fixes at once, and so limiting the suggestions may improve customer engagement. In some examples, the checks 110 (including each setting checked and corresponding suggested fix) may have a priority value assigned to it, so that the most useful or important suggestions from the scan may be presented to the user.

In some examples, the user may prefer a setting in its current state over the suggested change from the optimizer module 122. Accordingly, a user may choose (e.g., via admin dashboard 128 UI) not to receive the same suggestion again on future scans. Such a selection may be logged by optimizer agent 126 to hide those suggestions from future scans, or the selection may be provided to optimizer module 122, which may skip that scan in future optimizer runs or not provide an associated suggested fix.

The optimizer agent 126 may track which notifications or suggested fixes have been reviewed by the admin, and potentially which ones have been implemented (e.g., either manually or via an automatic “fix it for me” button). The viewing or implementation data may be provided from optimizer agent 126 to optimizer module 122.

Instead of or in addition to on-demand scans initiated by an admin via admin dashboard 128, optimization scans may be run at set intervals, at scheduled times, or based on an instruction from, e.g., development system 102. Scans may be run on individual customer application instances, or on groups or the entire fleet of application instances. For example, one or more regional optimizer services may each run scans on one or more customer application instances, in order to scan many or all customer application instances together.

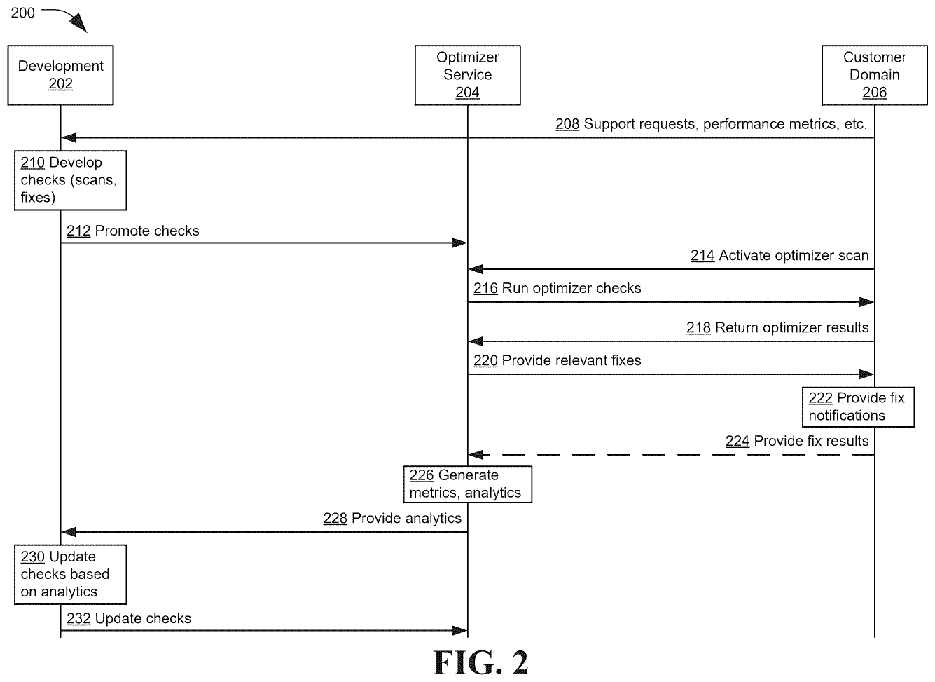

Optimizer module 122 may provide statistical information on scans, fixes, and other optimizer operations to analytics module 124. Analytics module may store, analyze, and compute various analytics metrics related to application optimization operations. For example, usage metrics may include a number of customers using optimizer scans or fixes on a daily, weekly, monthly, or quarterly basis, number of optimizer executions per time period per customer, a total number of optimizer service calls per time period, or maximum number of concurrent users. Resolution metrics may include a number and name of customers who fixed a check, a number of days it takes for a check to pass since its first failure, a number of customers where a check failed but is not yet fixed, a number and name of customers who haven't run a check, or an average closure time of checks for a customer within a week, month, etc. Issue discovery metrics may include a number of distinct checks run, a number of distinct issues per application instance on a time period basis, a number of distinct issues found per user role (e.g., payroll, admin, etc.) on a time period basis, a number of checks run within each optimizer execution, or number of passed and failed checks. Adoption metrics may include a number of fixes implemented from a check on a week on week basis by customers (e.g. based on a time to retire a check for a customer), a number of customers where a check was run erroneously (e.g., bad syntax, missing a table or column, or other issues) on a time period basis, or a count and name of customers who didn't run optimizer for more than, e.g., seven consecutive days. Issue resolution metrics may include a lifetime of a check (e.g., number of days it takes for a check to pass since its first failure), or an average closure time of checks for a customer in a week or month. Analytics may include a number of SRs coming in, time to resolution, and other factors. Metrics may further allow for “drilling down” or further delineating results, for example based on the application being checks, user roles the check applies to, which customers the values correspond to, more specific time delineations, or other values. The analytics module may provide the analytics results to developers through a UI of the development system 102, to customers through the admin dashboard 128, or both. The analytics may provide valuable feedback to development system 102 to further streamline, focus, correct, or adjust checks 110 to achieve higher success rates and customer adoption. A process flow for implementing an application optimization framework id discussed in regard to FIG. 2.

FIG. 2 is a flow diagram of an example system 200 for implementing an application optimization framework, in accordance with certain embodiments of the present disclosure. In particular, system 200 may include a development system 202, an optimizer service 204, and a customer domain 206. The components of system 200 may substantially correspond to the components development system 102, optimizer service 104, and customer domain 106 of FIG. 1.

At 208, development system 202 may obtain or receive support requests, application performance metrics, error logs, and other details from customer domain 206 about settings and performance of customer application instances. In some embodiments, the support requests, metrics, etc. may be provided from customer domain 206 to deployment system 202 by way of optimizer service 204. Based on the settings and performance details, development system 202 may develop one or more checks, at 210. Checks may include scans to perform on customer application instances that can determine if certain settings are enabled that may negatively impact performance or customer satisfaction. For example, a customer may set their application to log certain data as part of a diagnostics process, and then not disable the logging. This may result in slower application performance and consumer storage resources. In another example, a customer may have multiple jobs set to run at the same time every day, and then no jobs running for long periods of time. Adjusting the job run times to not overlap may improve performance. Scans may be generated in the form of database SQL queries or executable code that can be run on the customer application instances. Checks may also include fixes, which may include text describing settings issues; links to additional information, message boards, or frequently asked question (FAQ) repositories; descriptions on how to manually improve settings; and SQL commands or executable code that may automatically change settings of the customer application instance to address sub-optimal configurations identified by the scans. The checks may be promoted at 212, which may include storing the checks to a database located at or accessible by optimizer service 204.

At 214, customer domain 206 may submit a request to optimizer service 204 to activate an optimizer agent and run an optimizer process on an application instance in the customer domain 206. In some embodiments, optimizer service 204 may be set to perform optimizer scans on one or more customer application instances on a set schedule, at selected intervals, or in response to a request or command from development system 202.

In response to the request for an optimizer scan, optimizer service 204 may run one or more optimizer checks on the selected customer application instance, at 216. The checks to run may be retrieved from the database of checks promoted 212 from development system 202. The optimizer service 204 may run the checks or scans itself, or may spawn a pod or module to execute the checks, or may provide the checks to the customer domain 206 (e.g., to be run by an optimizer agent 126). At 218, the optimizer service 204 may receive the optimizer scan results from customer domain 206. The scan results may include details about which scans succeeded or failed, and which scans identified settings or configurations that could be improved or optimized.

In response to the scan results, the optimizer service 204 may provide relevant fixes to the customer domain 206, at 220. Relevant fixes may include information on the relevant settings, instructions on how to change the settings to improve application performance, and potentially commands or code that can be automatically executed by the customer to implement the suggested optimizations. Based on the scan results, 218, the received fixes 220, or both, the customer domain 206 may provide optimizer scan results and fix notifications to a user, at 222. For example, a UI of the customer domain 206 may notify an administrator for the customer about any improvement opportunities that were identified by the scan, and allow the admin to review and potentially implement the suggested fixes or optimizations. Details on which fixes the user implemented, if any, may be provided from the customer domain 206 to the optimizer service 204, at 224.

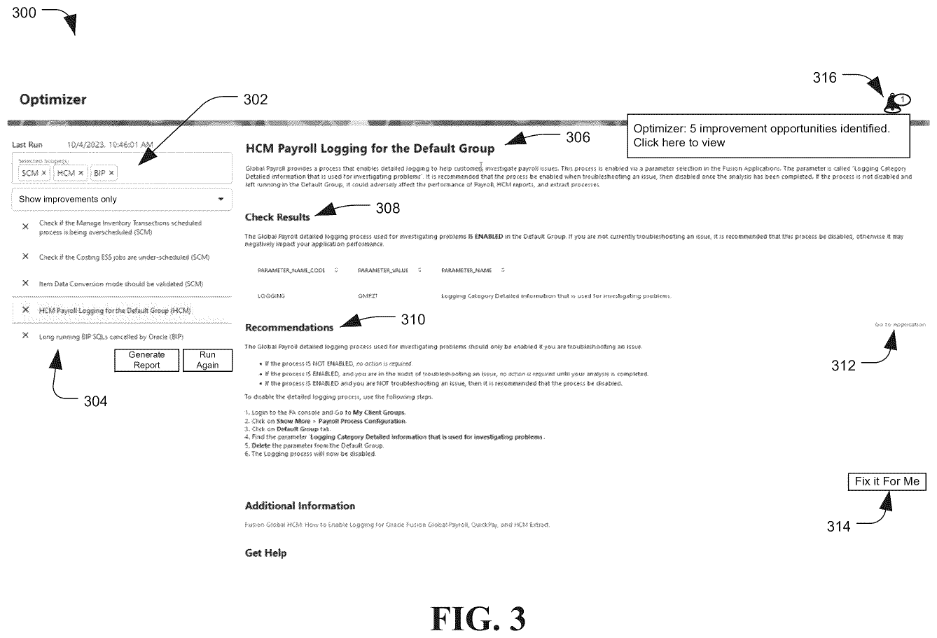

At 226, the optimizer service 204 may generate metrics, analytics, and other data based on optimizer scans, implemented fixes, errors encountered, timeframes, and other details about what checks have been successfully adopted by customers and have improved application performance. The analytics may be provided to the development system 202, at 228, allowing developers to review how successful the checks have been, whether customers are applying the fixes, whether fixes are performing as expected, and other relevant details. Based on the analytics, the development system 202 may update the checks, introduce new checks, retire outdated or irrelevant checks, and otherwise adapt the optimizer system based on customer usage feedback. At 232, the development system 202 may update the checks at the optimizer service 204. The updated checks may be used for future optimizer scans and fixes. An example of the administrator dashboard 128 interface for the optimizer framework is discussed in regard to FIG. 3.

FIG. 3 is a diagram 300 of a user interface for an application optimization framework, in accordance with certain embodiments of the present disclosure. In particular, diagram 300 may depict an example customer or administrator dashboard via which users may review optimizer scan results and suggested fixes. The diagram 300 may include an example of admin dashboard 128 of FIG. 1, and may receive optimizer scan results and suggested fixes from optimizer service 104, for example via optimizer agent 126.

In the depicted example embodiment 300, the UI may display a notification icon 316, which may notify the user of any improvement opportunities identified by recent optimizer scans. The notification may take the user to an optimizer screen as depicted in diagram 300. The optimizer screen may provide a summary 302 from an optimizer scan, such as when it was run, and what applications or portions of an application were scanned. The results may provide an option to see all the settings scans that were performed, or only displaying the scans that detected potential improvement opportunities. In the depicted example, five potential improvement opportunities are listed at 304. A user may also choose to generate a report of the scan results, or run an optimizer scan again.

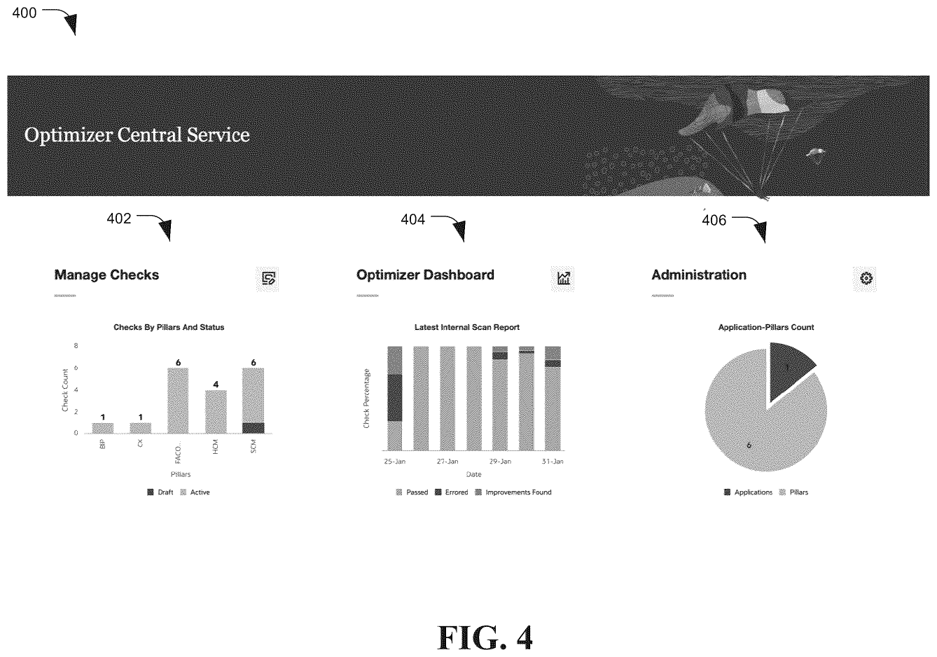

Selecting one of the improvement opportunities from list 304 may pull up specifics of the suggested improvement at 306, including a name of the settings or configuration, and a summary of the details for that setting or configuration. A check results section 308 may identify what the setting is currently set to, and how the setting may provide sub-optimal performance or results. A recommendations section 310 may provide a set of instructions on how to change or adjust the settings to optimize performance, including menus to go through and which options to select, and may provide a direct link 312 to the application, settings, or menu in question. The recommendations section 310 may also provide “additional information” and “get help” sections that provide further details on the settings, links to message boards or online support, or similar issues a user can review to find out more about the suggested optimizations. In some examples, the UI may provide a “fix it for me” button 314, which may cause code to run that automatically sets the application configuration to the suggested settings. After selecting “fix it for me” 314, the button may change to say “fixed”, or the UI may otherwise indicate that the suggested optimization has been implemented. In some embodiments, a customer user or admin may be able to utilize the UI to review statistics or metrics on optimizer scans run and fixes implemented. An example of a developer dashboard may be discussed in regard to FIG. 4.

FIG. 4 is a diagram 400 of a user interface for an application optimization framework, in accordance with certain embodiments of the present disclosure. In particular, diagram 400 may depict an example developer UI or dashboard of development system 102, via which application development or support personnel may manage checks, review optimizer analytics data, and otherwise interact with optimizer service 104. In the depicted example, diagram 400 may include a manage checks interface 402, an optimizer dashboard interface 404, and an administration interface 406.

A user may select the manage checks interface 402 to add, remove, update, or review the checks 110 that comprise the optimizer scan and fixes repository. The checks may include commands or code to run on the customer application instances to identify improvement opportunities, as well as corrective actions for a user to take or code or commands that users may activate to automatically optimize the application settings. Selecting the manage checks interface 402 may bring a user to a screen listing all checks, and for each check identifying a check ID, what application the check is for, whether it is active, a version number, a version date or publication date, environments to which it applies, or other details. A user may be able to select a check in order to update, retire, or create a new version, as well as to see additional details on the check.

A user may select the optimizer dashboard interface 404 to review or modify details on optimizer scans. The optimizer dashboard interface 404 may give a user access to multiple scan-related pages, such as pages regarding internal scans, scheduled scans, scan analytics, trend analytics, or other details. Each page may have further page delineations or tabs, such as scan analytics having tabs for job analytics, check analytics, and pod analytics. Job analytics may provide details on recent jobs that have been run, including whether the scans were internal or external, start times, end times, durations, how many pods were targeted, how many pods the job completed successfully and how many the job ended unsuccessfully or with errors. For each job, there may be details on what scans were performed or what pods the job was performed on. The check analytics tab may include analytics for individual checks, such as how many and which pods the check has been run against, and how many and which pods had improvement opportunities identified by the check. The pod analytics tab may provide details on specific pods, such as which pods have had checks run against them, which have identified improvement opportunities, when a last scan was run, or other pod-specific details.

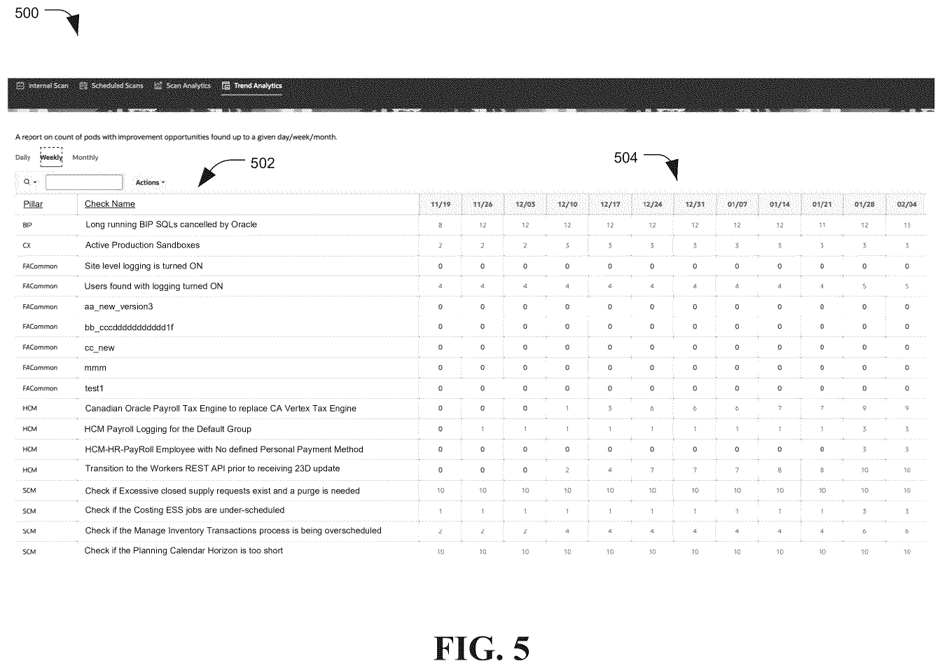

The administration interface 406 may take a user to a page for managing applications. For example, a developer may be able to look up, add, or modify applications and pillars, including general releases or specific customer instances of applications. An application can have one or more pillars, where a pillar may be a collection of features. Example Oracle applications may include Field Service Management, Commerce Cloud, Eloqua Marketing Automation, Responsys Campaign Management, Marketing Cloud, etc. Example Oracle pillars may include HCM (Human Capital Management), CRM (Customer Relationship Management), ERP (Enterprise Resource Planning), etc. FIG. 5 depicts an example of an interface page or tab from the optimizer dashboard interface 404.

FIG. 5 is a diagram 500 of a user interface for an application optimization framework, in accordance with certain embodiments of the present disclosure. In particular, diagram 500 may depict an example developer UI or dashboard of development system 102, via which application development or support personnel may evaluate trend analytics in optimizer checks. The trend analytics UI 500 may be one of the tabs or sub-pages reachable through the optimizer dashboard interface 404 of FIG. 4. In the depicted example, diagram 500 may include a list of checks 502 and a corresponding table of scan dates 504.

The list of check names 502 may identify various checks 110 that have been promoted to the optimizer service 104 for use in optimizer scans and fixes on customer application instances or pods within customer domain 106 of FIG. 1. One or more of the checks from the list 502 may be run as a scan on a customer application when the optimizer service is run. The optimizer scans may be run on one or more customer applications at selected intervals. The diagram 500 depicts a trend analysis table 504 for scan results based on weeks, but other UI tabs may show daily results, monthly results, or other time intervals.

The table of scan dates 504 may identify how many scanned pods or customer application instances had improvement opportunities identified from the corresponding scan 502 during the listed week. For example, the scan “Long running BIP SQLs cancelled by Oracle” detected eight improvement opportunities on 11/19, but twelve improvement opportunities on 11/26, indicating that four additional scanned pods had settings that could be optimized from the first week to the next. Between 01/14 and 01/21, the number of improvement opportunities decreased from 12 to 11, indicating that one of the pods implemented the setting changes to address the improvement opportunity during that week.

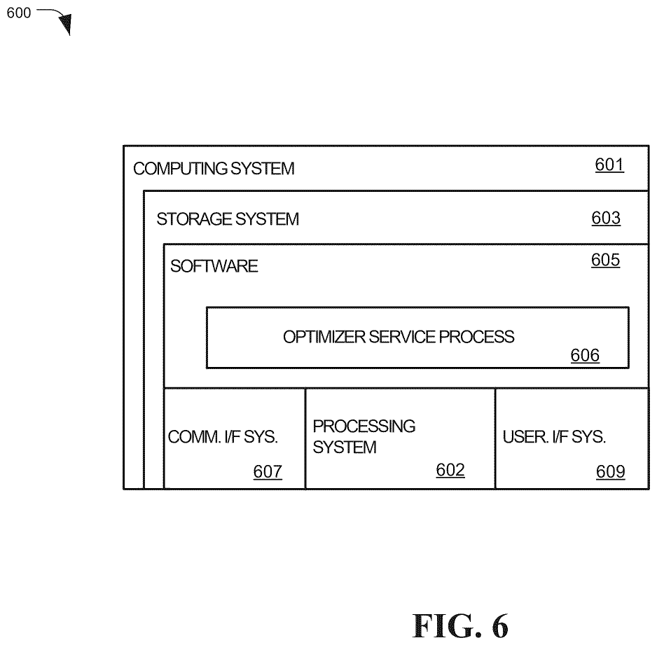

In this manner, developers may be able to track which checks and fixes are being adopted by customers or otherwise successfully implemented to address unoptimized settings, and which are not. Developers may evaluate checks based on these metrics to determine which are running correctly, which are popular among customers, and which may need to be adjusted or retired. A computing system configured to perform the operations and methods described herein is provided in regard to FIG. 6.

FIG. 6 illustrates an apparatus 600 including a computing system 601 that is representative of any system or collection of systems in which the various processes, systems, programs, services, and scenarios disclosed herein may be implemented. For example, computing system 601 may be an example of development system 102, optimizer service 104, optimizer module 122, analytics module 124, regional optimizer service 112, job control 108, customer domain 106, pods 114-120, optimizer agent 126, or admin dashboard 128 of FIG. 1. Examples of computing system 601 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 may include, but is not limited to, processing system 602, storage system 603, software 605, communication interface system 607, and user interface system 609. Processing system 602 may be operatively coupled with storage system 603, communication interface system 607, and user interface system 609.

Processing system 602 may load and execute software 605 from storage system 603. Software 605 may include and implement optimizer service process 606, which may be representative of any of the operations for providing a framework for developers to proactively address customer setup and configuration issues to relevant users, including managing checks, scheduling and running scans, proposing and implementing fixes, receiving and reporting metrics, evaluating success and uptake of fixes, and adapting checks to meet demand and obstacles, as discussed with respect to the preceding figures. When executed by processing system 602, software 605 may direct processing system 602 to operate as described herein for at least the various processes, operational scenarios, and sequences discussed in the foregoing implementations. Computing system 601 may optionally include additional devices, features, or functionality not discussed for purposes of brevity.

In some embodiments, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 may include general purpose central processing units, graphical processing units, application specific processors, and logic devices, as well as any other type of processing device, combinations, or variations thereof.

Storage system 603 may comprise any memory device or computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including optimizer service process 606 among other functions) may be implemented in program instructions that may, when executed by processing system 602, direct processing system 602 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to implement a bundled binding audit process as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. An application optimizer service system, comprising:
one or more processors; and
a memory having stored thereon instructions that, upon execution by the one or more processors, cause the one or more processors to implement an application optimizer process to improve performance of an application instance, wherein the application optimizer service system is executed in a developer domain and the application instance is executed in a customer domain, the application optimizer process including:
receive a plurality of checks from an application development system for the application instance, the plurality of checks including scans and fixes for configuration settings of the application instance;
receive a request to run an optimizer service on the application instance;
execute the scans on the application instance in response to the request;
based on a result of the scans, determine a selection of fixes configured to improve the performance of the application instance;
provide a notification to the application instance recommending user implementation of the selection of fixes; and
provide analytics data corresponding to the user implementation of the selection of fixes to the application development system.

2. The application optimizer service system of claim 1, wherein the request to run the optimizer service is received from an optimizer agent running in the customer domain.

3. The application optimizer service system of claim 1, wherein the request to run the optimizer service is based on a scheduled scan set by the application development system in the developer domain.

4. The application optimizer service system of claim 3, further comprising instructions that, upon execution, cause the one or more processors to:
perform the scheduled scan on a plurality of customer application instances including the application instance; and
determine separate selections of fixes for each of the plurality of customer application instances.

5. The application optimizer service system of claim 4, further comprising instructions that, upon execution, cause the one or more processors to:
generate the analytics data based on user implementations of the separate selections of fixes from the plurality of customer application instances.

6. The application optimizer service system of claim 5, further comprising instructions that, upon execution, cause the one or more processors to:
maintain a database of the plurality of checks; and
provide an API (application programming interface) to the application development system enabling modification of the plurality of checks.

7. The application optimizer service system of claim 6, wherein the fixes include instructions to manually adjust the configuration settings to improve performance.

8. The application optimizer service system of claim 7, wherein the fixes include instructions executable by the customer domain to automatically adjust the configuration settings in response to a button selection by a user.

9. The application optimizer service system of claim 8, further comprising instructions that, upon execution, cause the one or more processors to:
determine the selection of fixes to include a subset less than all of the fixes identified by the scans that could improve the performance of the application instance.

10. The application optimizer service system of claim 9, wherein executing the scans on the application instance includes:
create a job control pod configured to:
retrieve the scans from the database;
run the scans on the application instance;
receive the result of the scans from the application instance; and
provide the result of the scans to the application optimizer service system.

11. A method comprising:
operating an application optimizer service system to implement an application optimizer process to improve performance of an application instance, wherein the application optimizer service system is executed in a developer domain and the application instance is executed in a customer domain, the application optimizer process including:
receiving a plurality of checks from an application development system for the application instance, the plurality of checks including scans and fixes for configuration settings of the application instance;
receiving a request to run an optimizer service on the application instance;
executing the scans on the application instance in response to the request;
determining a selection of fixes configured to improve the performance of the application instance in response to a result of the scans;
providing a notification to the application instance recommending user implementation of the selection of fixes; and
providing analytics data corresponding to the user implementation of the selection of fixes to the application development system.

12. The method of claim 11, wherein the request to run the optimizer service is received from an optimizer agent running in the customer domain.

13. The method of claim 11, wherein the request to run the optimizer service is based on a scheduled scan set by the application development system in the developer domain.

14. The method of claim 13, further comprising:
performing the scheduled scan on a plurality of customer application instances including the application instance; and
determining separate selections of fixes for each of the plurality of customer application instances.

15. The method of claim 14, further comprising:
generating the analytics data based on user implementations of the separate selections of fixes from the plurality of customer application instances.

16. The method of claim 11, further comprising:
maintaining a database of the plurality of checks; and
providing an API (application programming interface) to the application development system enabling modification of the plurality of checks.

17. The method of claim 16, wherein executing the scans on the application instance includes:
creating a job control pod configured for:
retrieving the scans from the database;
running the scans on the application instance;
receiving the result of the scans from the application instance; and
providing the result of the scans to the application optimizer service system.

18. The method of claim 11 wherein the fixes include instructions to manually adjust the configuration settings to improve performance.

19. The method of claim 11, wherein the fixes include instructions executable by the customer domain to automatically adjust the configuration settings in response to a button selection by a user.

20. The method of claim 11, further comprising:
determining the selection of fixes to include a subset less than all of the fixes identified by the scans that could improve the performance of the application instance.
